(19) United States
(12) Patent Application Publication
(10) Pub. No.: US 2024/0331423 A1
(43) Pub. Date: Oct. 3, 2024

(54) ONE-SHOT MULTIMODAL LEARNING FOR DOCUMENT IDENTIFICATION

(71) Applicant: IRON MOUNTAIN INCORPORATED, Portsmouth, NH (US)

(72) Inventors: Zhihong Zeng, Acton, MA (US); Sushant Tiwari, New York, NY (US); Jonathan Hirscher, Manassas, VA (US); Zhi Chen, Montreal (CA); Narasimha Goli, Tampa, FL (US)

(73) Assignee: IRON MOUNTAIN INCORPORATED, Portsmouth, NH (US)

(21) Appl. No.: 18/604,902

(22) Filed: Mar. 14, 2024

Related U.S. Application Data
(60) Provisional application No. 63/454,830, filed on Mar. 27, 2023.

(51) Int. Cl. G06V 30/19; G06V 20/62; G06V 30/14; G06V 30/18; G06V 30/413; G06V 30/416; G06V 30/42

(52) U.S. Cl. CPC G06V 30/19147; G06V 20/62; G06V 30/1444; G06V 30/18019; G06V 30/413; G06V 30/416; G06V 30/42

(57) ABSTRACT

In some embodiments, techniques are provided for document identification using a multimodal model that has been trained using one-shot learning. In one example, a first method of document image processing includes generating, for each template document image of a plurality of template document images, a corresponding fingerprint of a plurality of fingerprints; and based on the plurality of fingerprints, training a multimodal model. For each template document image of the plurality of template document images, generating the corresponding fingerprint may include detecting a plurality of regions within the template document image, wherein the plurality of regions comprises a plurality of text regions; and filtering the plurality of regions to obtain a plurality of regions of interest, wherein the fingerprint is based on the plurality of regions of interest.

### CROSS-REFERENCE TO RELATED APPLICATION

This claims priority to U.S. Provisional Application Ser. No. 63/454,830, filed Mar. 27, 2023 and titled “ONE-SHOT MULTIMODAL LEARNING FOR DOCUMENT IDENTIFICATION,” the contents of which are incorporated herein by reference.

### TECHNICAL FIELD

The field of the present disclosure relates to document processing. More specifically, but not necessarily exclusively, the present disclosure relates to techniques for document identification using a multimodal model that has been trained using one-shot learning.

### BACKGROUND

Automatic document classification is an important application of natural language understanding and computer vision. Existing data-driven machine learning (ML) methods for automatic document classification are based on a large number of training samples for each class.

### SUMMARY

Certain embodiments involve document identification using a multimodal model that has been trained using one-shot learning. In some examples, a method of document image processing includes generating, for each template document image of a plurality of template document images, a corresponding fingerprint of a plurality of fingerprints; and based on the plurality of fingerprints, training a multimodal model. For each template document image of the plurality of template document images, generating the corresponding fingerprint may include detecting a plurality of regions within the template document image, wherein the plurality of regions comprises a plurality of text regions; and filtering the plurality of regions to obtain a plurality of regions of interest, wherein the fingerprint is based on the plurality of regions of interest.

In some examples, a method of document image processing includes generating a multimodal feature vector from a query document image, and generating an identification prediction by processing the multimodal feature vector using a multimodal model that has been trained according to the first method. The multimodal feature vector includes, for each text region of a plurality of text regions of the query document image, an indication of textual content of the text region and an indication of a location of the text region within the query document image. The multimodal feature vector can also include, for each image patch of a plurality of image patches of the query document image, an indication of image content of the image patch and an indication of a location of the image patch within the query document image.

These illustrative embodiments are mentioned not to limit or define the disclosure, but to provide examples to aid understanding thereof. Additional embodiments are discussed in the Detailed Description, and further description is provided therein.

### BRIEF DESCRIPTION OF THE DRAWINGS

Features, embodiments, and advantages of the present disclosure are better understood when the following Detailed Description is read with reference to the accompanying drawings.

FIG. 1 shows a block diagram of a computing environment according to certain aspects of the present disclosure.

FIGS. 2A and 2B show two examples of template document images from a set of images of blank forms according to certain aspects of the present disclosure.

FIGS. 3A and 3B show two examples of template document images from a set of images of blank forms according to certain aspects of the present disclosure.

FIG. 4A shows a block diagram of an implementation of a region extracting module according to certain aspects of the present disclosure.

FIG. 4B shows a block diagram of an implementation of a training input generating module according to certain aspects of the present disclosure.

FIG. 4C shows a block diagram of an implementation of a data augmentation module according to certain aspects of the present disclosure.

FIG. 5 shows an example of text bounding boxes in a portion of a template document image according to certain aspects of the present disclosure.

FIG. 6 shows an example of a result obtained by applying a region filtering module according to certain aspects of the present disclosure.

FIG. 7 shows an example of verification of pre-annotations on a sample template according to certain aspects of the present disclosure.

FIG. 8 shows an example of a query document image according to certain aspects of the present disclosure.

FIG. 9 shows an example of feature detection results for a fingerprint that matches a query document image according to certain aspects of the present disclosure.

FIG. 10 shows an example of feature detection results for a fingerprint that does not match a query document image according to certain aspects of the present disclosure.

FIG. 11 shows a flowchart of a process of multimodal model training according to certain aspects of the present disclosure.

FIG. 12 shows a flowchart of a process of document identification according to certain aspects of the present disclosure.

FIG. 13 shows a block diagram of an example computing device according to certain aspects of the present disclosure.

### DETAILED DESCRIPTION

The subject matter of embodiments of the present disclosure is described here with specificity to meet statutory requirements, but this description is not necessarily intended to limit the scope of the claims. The claimed subject matter may be implemented in other ways, may include different elements or steps, may be used in conjunction with other existing or future technologies, or any combination thereof. This description should not be interpreted as implying any particular order or arrangement among or between various acts or elements except when the order of individual acts or arrangement of elements is explicitly described.

Automatic document classification is an important application of natural language understanding and computer vision. Existing data-driven machine learning (ML) methods for automatic document classification are based on a large number of training samples for each class. The task of obtaining and labeling a sufficient number of data samples to provide a corpus of training data that is large enough to support a reliable classification result may be time-consuming and expensive. The problem of how to build a high-quality model using only one or few training samples for each class to be identified remains challenging.

Certain aspects and examples of the present disclosure relate to techniques for document identification using a multimodal model trained using one-shot learning. A computing platform may access images of template documents and perform processing operations on the template document images. In some examples, the processing can include text region detection, which may include performing optical character recognition on the detected text regions. In some examples, the processing can include image region detection. For each of the template document images, the processing may include generating a corresponding fingerprint, such as a multimodal feature vector, that can be characteristic of the template document image and that can be based on the regions detected in the image and on image information from the image.

The computing platform may use the fingerprints to train a multimodal model to detect features of the fingerprints within multimodal input feature vectors. The training may be based on the fingerprints and may also be based on additional multimodal training inputs that can be generated from the template document images by data augmentation. The computing platform may apply the trained multimodal model to identify query document images by generating multimodal feature vectors from the query document images and using the multimodal model to detect features of the fingerprints within the multimodal feature vectors. The computing platform may evaluate the identification predictions to determine which fingerprint has been detected, to determine that the gallery of fingerprints does not include a fingerprint that matches the query document image under test, or a combination thereof.

Techniques presented herein may be utilized to determine whether a document is from the targeted categories in a gallery, and, if so, to identify the category to which the document belongs. Such techniques may include extracting a distinctive fingerprint from each of a set of standard documents, such as forms, to be identified. In some examples, the fingerprints may be used to train a multimodal model to generate high-quality predictions using one-shot learning.

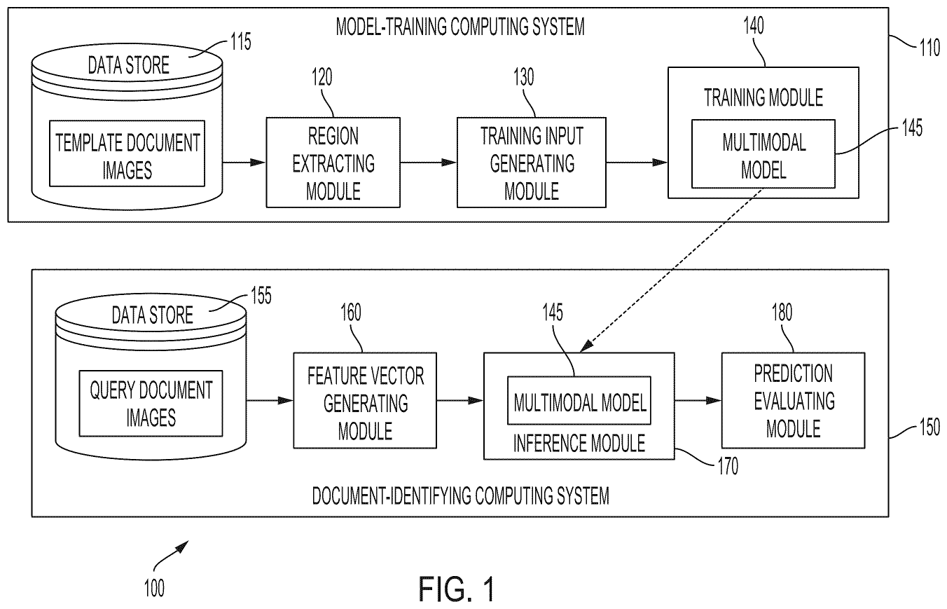

FIG. 1 shows a block diagram of a computing environment 100, according to certain aspects of the present disclosure. As illustrated in FIG. 1, the computing environment 100 includes (i) a model-training computing system 110 that is configured to train a multimodal model based on information from images of template documents, and (ii) a document-identifying computing system 150 that can use the trained multimodal model to generate identification predictions for images of query documents. The model-training computing system 110 can include a data store 115 for storing a set of template document images, a region extracting module 120 for extracting regions of interest (ROIs) from the template document images, a training input generating module 130 for generating training inputs from the template document images and ROIs, and a training module 140 for using the training inputs to train the multimodal model. The model-training computing system 110 may include any suitable additional or alternative modules. Each of the modules 120, 130, and 140 may execute on one or more corresponding servers of the system 110, and one or more of the modules 120, 130, and 140 may execute at least partially on the same server or servers.

Each template document image of the set of template document images may be unique among the set of template document images. In one such example, the set of template document images can be or include a set of images of blank, or unpopulated, forms, and each template document image included in the set of template document images can be or include an image of a different corresponding one of the blank forms. Each of the blank forms may be digital-born or pre-printed, and each of the template document images may be obtained by capturing an image of the document (e.g., scanning) or by converting from an image in a different format such as by converting from Portable Document Format (PDF) to Tagged Image Format (TIF).

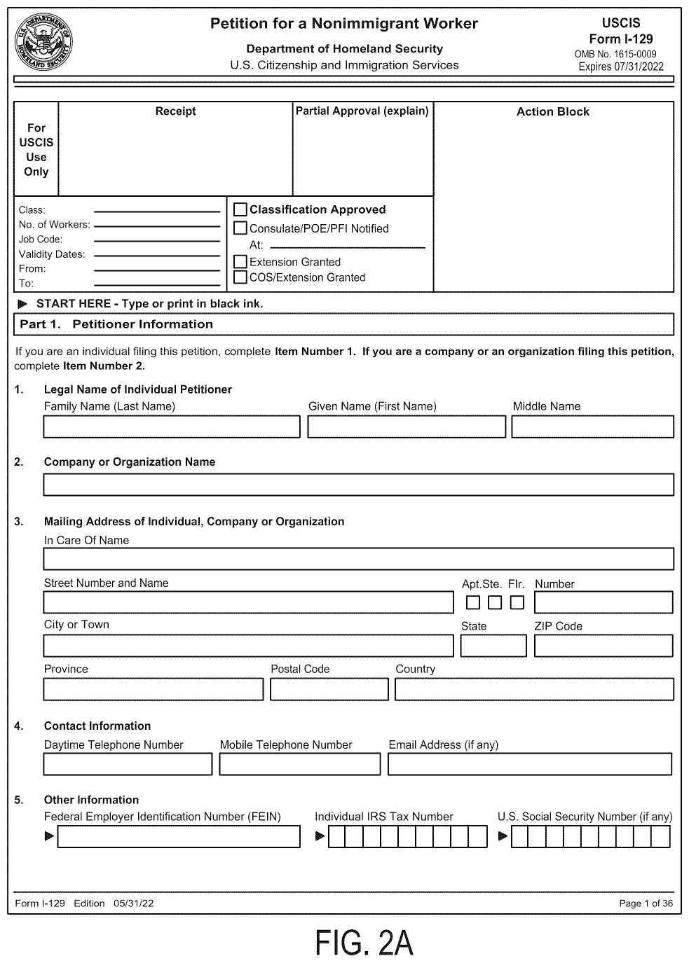

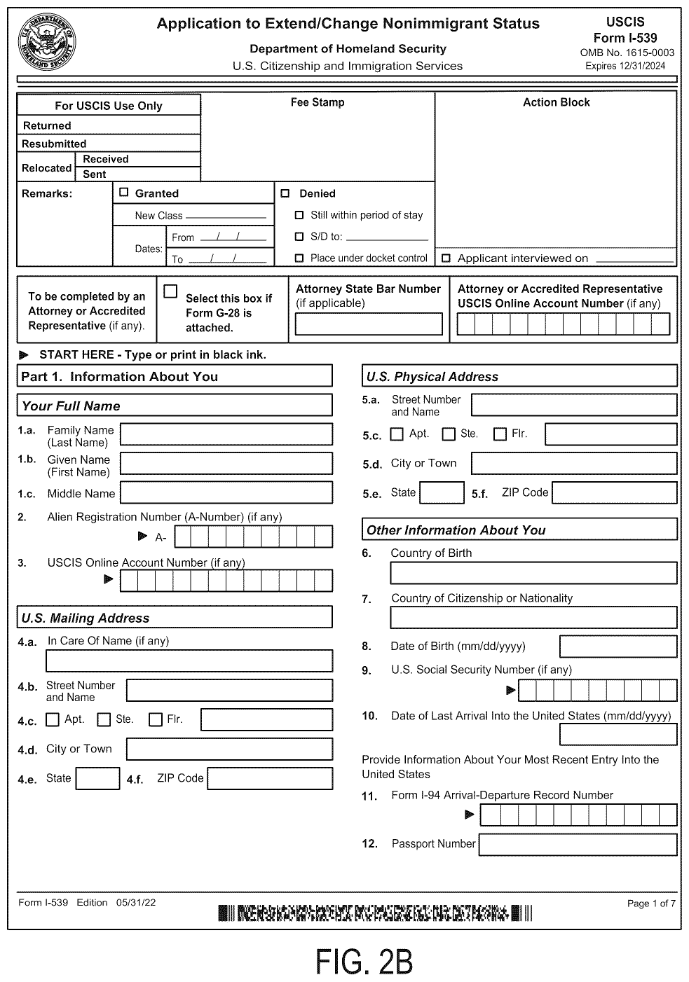

FIGS. 2A and 2B illustrate two examples of template document images from a set of images of blank forms. Each of the examples illustrated by FIGS. 2A and 2B can be or include an image of a different corresponding blank form of the set of images of blank forms. In some examples, such as examples in which one or more of the template documents has multiple pages, each unique page among the template documents may be, or may be considered to be, a template document. In some cases, a set of images of blank forms may include two or more images of different corresponding versions (e.g., versions of a prototype), or editions, of a form document. FIGS. 3A and 3B illustrate two examples of template document images from a set of images of blank forms in which each of the examples is an image of a different corresponding edition of a form document.

The region extracting module 120 can be configured to generate, for each template document image of the set of template document images, a corresponding fingerprint. As used herein, the term “fingerprint” can refer to a set of features, such as in the form of a feature vector, that is characteristic of a particular template document image and may be used to identify instances of the template document image (e.g., images of populated instances of the template document) from among instances of other template document images.

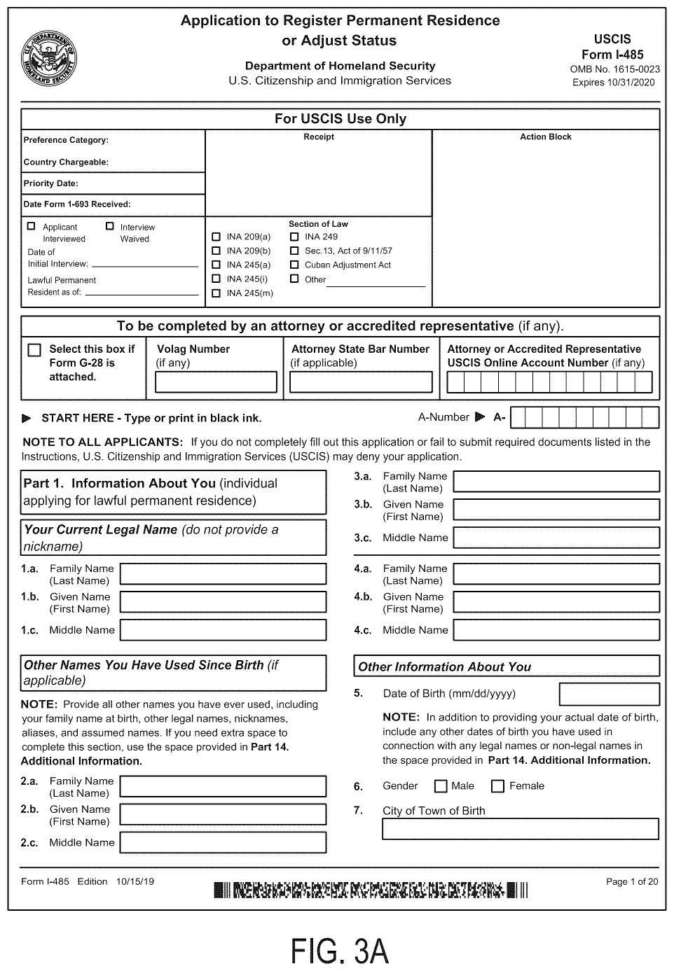

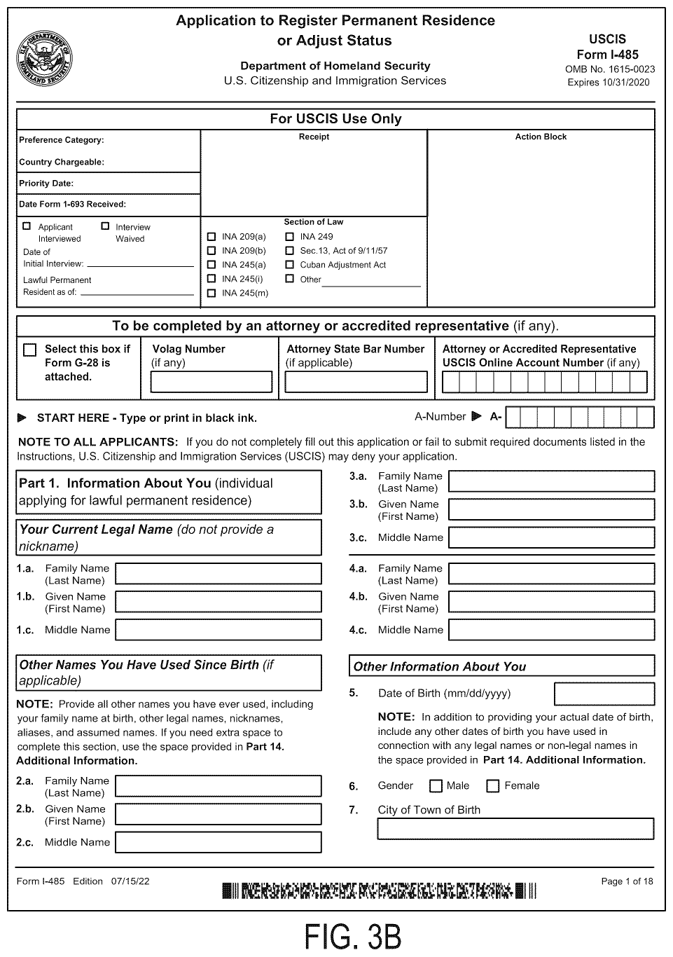

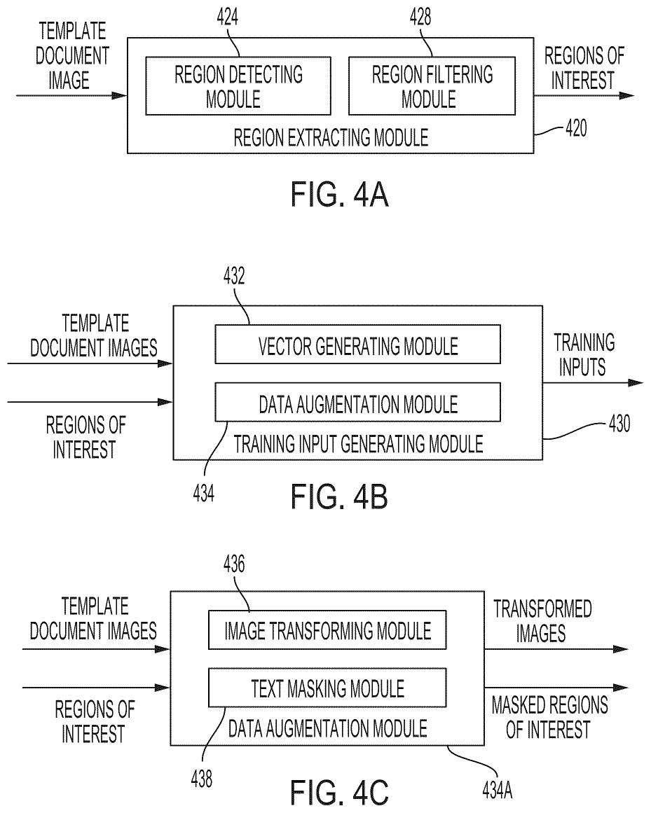

FIG. 4A illustrates a block diagram of an implementation 420 of the region extracting module 120 that includes a region detecting module 424 and a region filtering module 428. The region detecting module 424 can be configured to detect a set of regions within the template document image, and the set of regions can include a set of text regions. As used herein, the term “text region” can refer to a region of a document image whose semantic content is indicated by text characters, such as letters or numbers, within the region. The region filtering module 428 can be configured to filter the set of regions to obtain a set of regions of interest, and the fingerprint can be based on the set of regions of interest.

The region detecting module 424 may be configured to indicate, for each of the detected text regions within the template document image, a bounding box that indicates a boundary of the text region within the image. A bounding box may be indicated by information sufficient to identify the two-dimensional (2D) coordinates of the vertices, such as four corners, of the bounding box within the corresponding document image. In some examples, a bounding box can be indicated by the 2D coordinates of one corner (e.g., the upper-left corner) together with the width and height of the bounding box (e.g., in pixels). In other examples, a bounding box can be indicated by the 2D coordinates of two opposite corners (e.g., the upper-left and lower-right corners) of the bounding box.

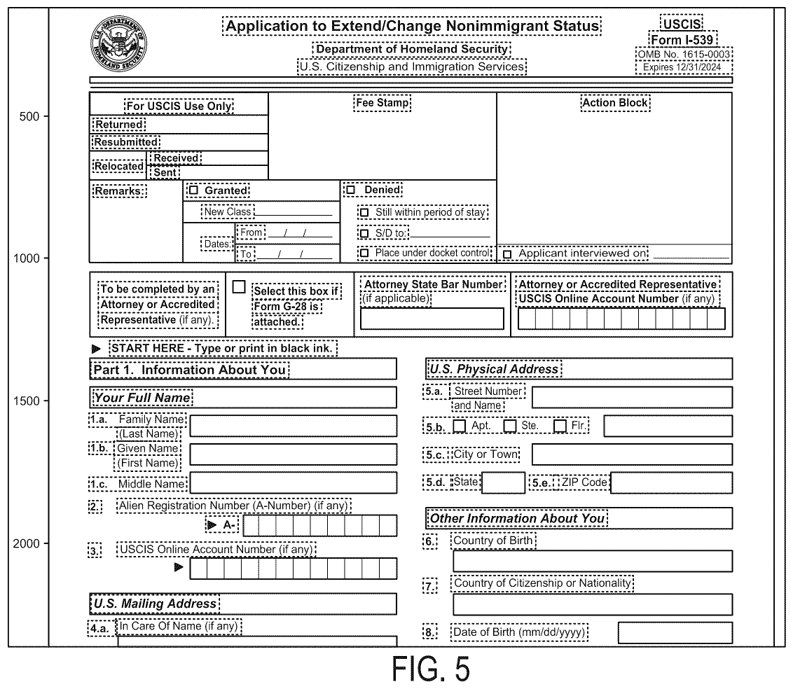

The region detecting module 424 may also be configured to produce, for each of the detected text regions, a text string from an indicated portion of the corresponding document image. As used herein, the term “text string” can refer to a string of text characters, such as letters, numbers, and special (e.g., punctuation or symbol) characters (and possibly including one or more line breaks). A text string may be, for example, a key word, a phrase, or a sentence. For the text regions detected by the region detecting module 424, the indicated portion of the corresponding document image may be the portion bounded by the bounding box. For example, the region detecting module 424 may be configured to perform optical character recognition (OCR) on each of the detected text regions, as indicated by the corresponding bounding boxes, to produce the corresponding text string. The region detecting module 424 may also be configured to indicate, for each of the detected text regions, a confidence of the OCR result. FIG. 5 illustrates an example of a portion of a template document image in which detected text regions are indicated by their corresponding bounding boxes.

The region filtering module 428 is configured to filter the set of regions to obtain a set of regions of interest. In some examples, the region filtering module 428 is configured to perform, for each template document image of the set of template document images, a filtering process that includes at least a first stage and a second stage. The first stage includes applying a first filter to select, from among the set of regions, a first set of selected regions. The second stage includes applying a second filter to omit, from among the first set of selected regions, at least one selected region to obtain a second set of selected regions.

The first filter may be or include a general filter that can select regions according to criteria such as, for example, a size of the corresponding text string, presence of a non-stop word in the corresponding text string, etc. Text pre-processing can include filtering out the words, which may be or include “stop words,” in a “stop list.” The stop words may be commonly used in the respective language such that the stop words may carry negligible amounts of useful information. Examples of stop words in English can include “a”, “the”, “is”, “are”, etc. A “non-stop word” may be expected to carry more useful information than most other words in the same document. For example, words that are longer (e.g., have more characters) than most other words may be identified as non-stop words. In some examples, applying the first filter includes selecting at least one text region from among the set of text regions based at least on a number of characters in the text region. Additionally or alternatively, applying the first filter may include selecting at least one text region from among the set of text regions based at least in part on a list of non-stop words. The list of stop words and/or the list of non-stop words may be general or may be specific to the particular set of standard documents to be matched such as tax forms, patent office forms, medical intake forms, and the like.

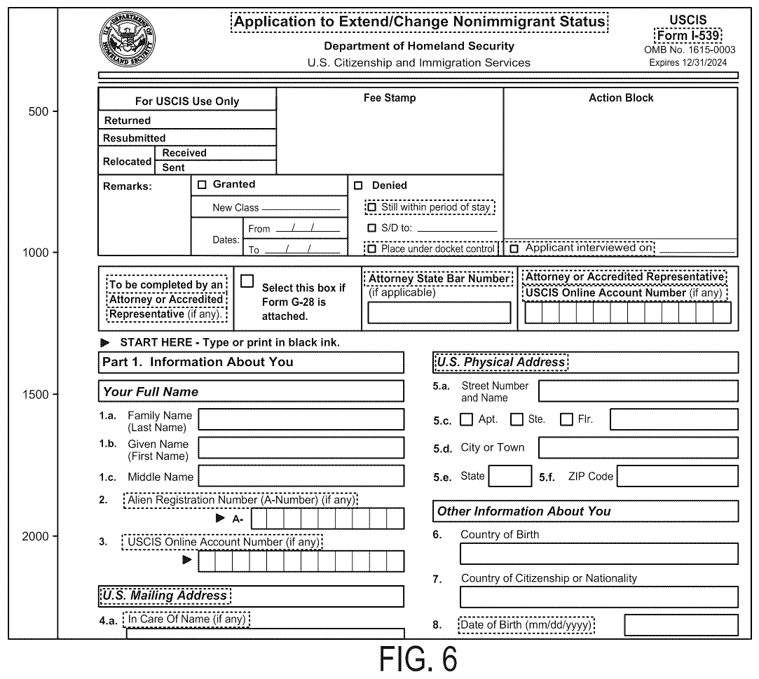

The second filter may be a discriminative filter that can omit elements, such as text that is common across the targeted categories, that may be common among the set of template document images. In some examples, applying the second filter can include omitting at least one region of the at least one selected region based on a number of occurrences of the region among the set of templates. FIG. 6 illustrates an example of a result obtained by applying the region filtering module 428 to the portion of the template document image illustrated in FIG. 5.

In some examples, a region whose content is common among the set of template document images may be distinctive in that its location within its corresponding template document image (e.g., as indicated by its bounding box) may be different than the locations of the other regions having the common content within their corresponding template document images. It may be desired for the second filter to include, among the second set of selected regions, regions having common content but distinctive locations.

The set of ROIs can be based on a result of filtering the regions such as based on the second set of selected regions. In some examples, one or more additional operations may be performed to add one or more regions to the second set of selected regions, and/or to remove one or more regions from the second set of selected regions, to obtain the set of ROIs. For example, the second set of selected regions may be reviewed by one or more labelers to verify and/or modify the features to be included in the fingerprint. Additionally or alternatively, the labelers may add or remove text regions, image patches (e.g., stamples), or other salient features. In other examples, a human or an automated process may add one or more image regions to the set of ROIs (e.g., an image region whose content and/or location is distinctive to the corresponding template document). Each of the image regions may indicate image content of the image region and a boundary of the image region within the corresponding template document image.

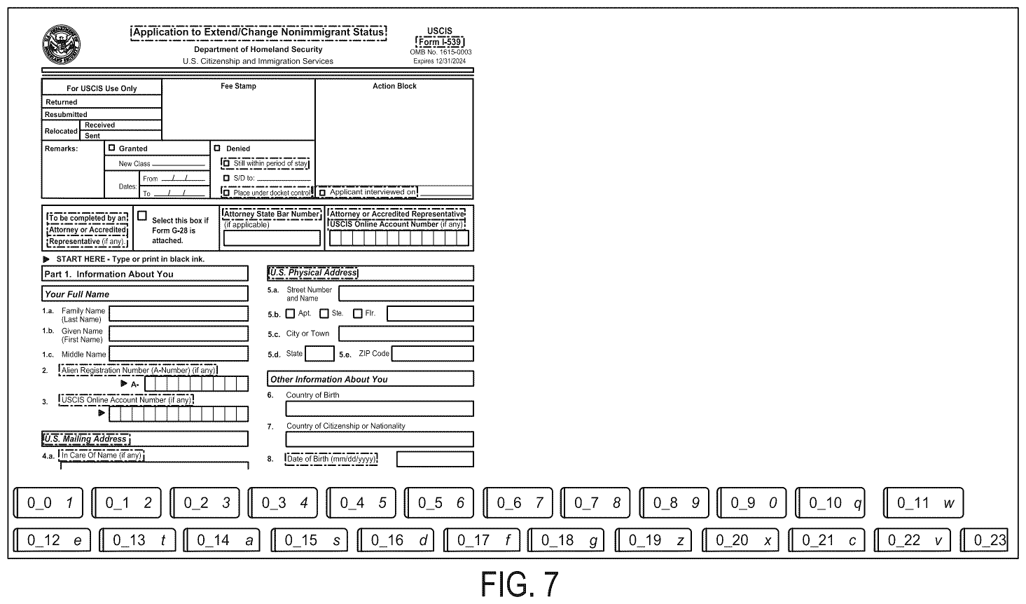

FIG. 7 illustrates an example of such verification of pre-annotations on a sample template. Additionally or alternatively, FIG. 7 illustrates an example in which each selected feature (e.g., text region) is assigned a label “x_y” in which x indicates the fingerprint ID number (in this example, 0) and y indicates the feature index number (in this example, 0 to 23).

The training input generating module 130 is configured to generate training inputs from the template document images and ROIs. FIG. 4B illustrates a block diagram of an implementation of the training input generating module 130 that includes a vector generating module 432 and a data augmentation module 434. For each template document image among the set of template document images, the vector generating module 432 generates a corresponding fingerprint by combining, such as by concatenating, information that indicates content and location of the text regions with information that indicates content and location of image patches of the template document image. The vector generating module 432 can generate a corresponding fingerprint as a multimodal feature vector that includes text embedding information from the corresponding ROIs (including word embedding and position embedding information) and image embedding information from the template document image. The vector generating module 432 may be configured to generate the image content and location information by resizing the template document image, dividing the resized image into patches, generating linear projections of the image patches, and associating each of the projections with its respective location within the image. The fingerprint may also include a tag that identifies the corresponding template document. The fingerprints generated from each template document image of the set of template document images may be collectively referred to as a “gallery” and may be stored, for example, in the data store 115.

As described above, the vector generating module 432 generates a corresponding fingerprint for each template document image among the set of template document images, and the training module 140 uses the resulting set of fingerprints for one-shot multimodal training of the multimodal model 145. It may be desired to generate additional training data to support training of the multimodal model 145 by the training module 140. Such generation of additional training inputs by the training input generating module 430 is now described.

The training input generating module 430 can include a data augmentation module 434 that is configured to generate augmented data based on the ROIs and the template document images. FIG. 4C illustrates a block diagram of an implementation 434A of the data augmentation module 434 that includes an image transforming module 436 and a text masking module 438. The image transforming module 436 generates one or more transformed images by performing one or more image transformation operations, such as, scale, translation, and degrading, etc., on the template document image. The text masking module 438 can generate one or more masked ROIs by text masking such as by masking word tokens of an ROI at random or pseudo-random to generate a masked ROI.

The vector generating module 432 is configured to generate additional multimodal feature vectors from the augmented data, such as from the transformed images and masked ROIs, and the training input generating module 430 can output the generated fingerprints and the additional multimodal feature vectors as the training inputs. In some examples, the vector generating module 432 is configured to generate each of the additional multimodal feature vectors by combining, such as by concatenating, information that indicates content and location of text ROIs of a template document image with information that indicates content and location of image patches of the template document image. In some examples, at least one of the text ROIs can be substituted with a corresponding masked ROI and/or the template document image can be substituted with a corresponding transformed image for image patching.

As illustrated in FIG. 1, the model-training computing system 110 includes a training module 140 that can be configured to use the training inputs to train the multimodal model 145. For example, the training module 140 may be configured to train the multimodal model 145 to process an input feature vector to predict detection of the features of one or more of the fingerprints within the input feature vector.

In some examples, the training module 140 is configured to train a multimodal model 145 that can be or include a version of a LayoutLM model to predict detection of the features of the set of fingerprints within an input feature vector. The model 145 may be or include an instance of a LayoutLMv3 model that includes a Transformer encoder with approximately twelve hidden layers, approximately twelve-head self-attention (e.g., twelve attention heads for each attention layer in the Transformer encoder), a hidden size (e.g., dimension of the encoder layers and the pooler layer) of approximately 768, and an intermediate size (e.g., dimension of the “intermediate” (i.e., feed-forward) layer in the Transformer encoder) of approximately 3,072. In other examples, the training module 130 is configured to train multiple multimodal models in which each of the models is trained to detect the features of a respective subset of (e.g., one or more, but fewer than all of) the fingerprints.

The multimodal model 145 may be pre-trained on a large dataset such as a portion of the Illinois Institute of Technology (IIT) Complex Document Information Processing (CDIP) dataset, National Institute of Standards and Technology (data.nist.gov). Pre-training strategies may include text token masking, image token masking, and/or learned alignment of text tokens and image tokens.

The training input generating module 130 and/or the training module 140 may be configured to pre-process and/or split the training inputs into sets for training, validation, and testing. For example, the set of fingerprints and some of the additional multimodal feature vectors may be included in the training set, and the other additional multimodal feature vectors may be distributed into the validation and testing sets.

The training module 140 can be configured to train and evaluate the multimodal model 145 and may save the trained fingerprint model or models 145 to a model farm. The document-identifying computing system 150 may be configured to load a selected trained model or models 145 (e.g., from the training module 140 and/or from the model farm) to the inference module 170 for model testing and/or document identifying.

As illustrated in FIG. 1, the document-identifying computing system 150 includes a data store 155 for storing a set of query document images, a feature vector generating module 160 for generating feature vectors from the query document images, an inference module 170 for using the trained multimodal model 145 to generate document identification predictions from the feature vectors, and a prediction evaluating module 180 for evaluating the document identification predictions. Each of the modules 160, 170, and 180 may execute on one or more corresponding servers of the document-identifying computing system 150, and one or more of the modules 160, 170, and 180 may execute at least partially on the same server or the same servers. Likewise, one or more of the servers of the system 150 may also be or be included in a server of the system 110.

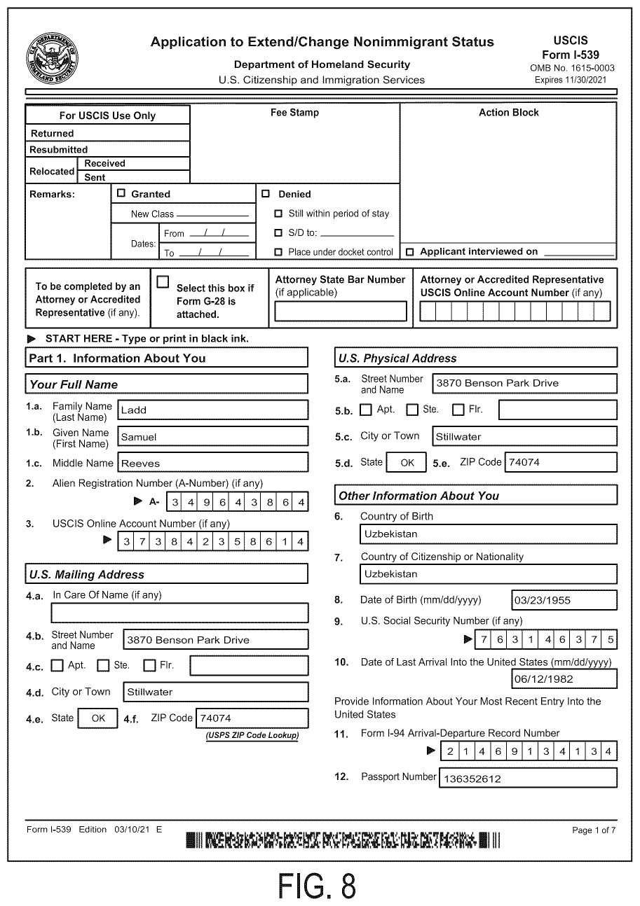

In examples in which the document-identifying computing system 150 stores or receives the query documents in a document file format (e.g., PDF), the document-identifying computing system 150 may include a conversion module that is configured to convert the query documents from the document file format into query document images in an image file format (e.g., TIFF). For example, the conversion module may be configured to convert each page of a query document file into a corresponding page image. Query document images obtained by scanning or otherwise digitizing the pages of query documents may already be in an image file format. FIG. 8 illustrates an example of a query document image that is an image of a populated form.

The feature vector generating module 160 may include a pre-processing module that can be configured to pre-process query document images prior to region detection. Pre-processing of the query document images may include, for example, any of the following operations: de-noising (e.g., Gaussian smoothing), affine transformation (e.g., de-skewing, translation, rotation, and/or scaling), perspective transformation (e.g., warping), normalization (e.g., mean image subtraction), histogram equalization, and the like. Pre-processing may include, for example, scaling the query document images to a uniform size. In some examples, the feature vector generating module 160 may be configured to process, or to otherwise perform region detection on, input images of a particular size such as 640 pixels wide×480 pixels high, 850 pixels wide×1100 pixels high, 1275 pixels wide×1650 pixels high, and the like.

The feature vector generating module 160 may include an instance of the region detecting module 424 that can be arranged to detect a set of regions within the query document image in which the set of regions can include a set of text regions. As described above, such region detection may include an OCR operation that extracts text content and an image location (e.g., bounding box) for each of a set of text regions. The feature vector generating module 160 may include an instance of the vector generating module 432 that can be arranged to generate a multimodal feature vector by combining, such as by concatenating, information that indicates content and location of the text regions with information that indicates content and location of image patches of the query document image. As described above, the instance of the vector generating module 432 may be configured to generate the image content and location information by generating linear projections of the image patches and associating each of the projections with its respective location within the image.

The inference module 170 is configured to process the feature vectors, using the trained multimodal model 145, to generate corresponding document identification predictions. For example, the inference module 170 may perform a fingerprint search, such as via feature or ROI detection, on a feature vector that is generated from a query document image by the feature vector generating module 160. In some examples, the inference module 170 can be configured to generate document identification predictions for a query document image as an output vector that indicates, for each feature of each fingerprint among the set of fingerprints, whether the feature is detected in the feature vector of the query document image. The output vector may indicate, for each feature, a predicted confidence that the feature is detected in the feature vector or otherwise in the query document image. In some examples, the inference module 170 can generate the output vector by feeding output of a final hidden layer of the trained multimodal model 145 to a multilayer perceptron (MLP) classifier.

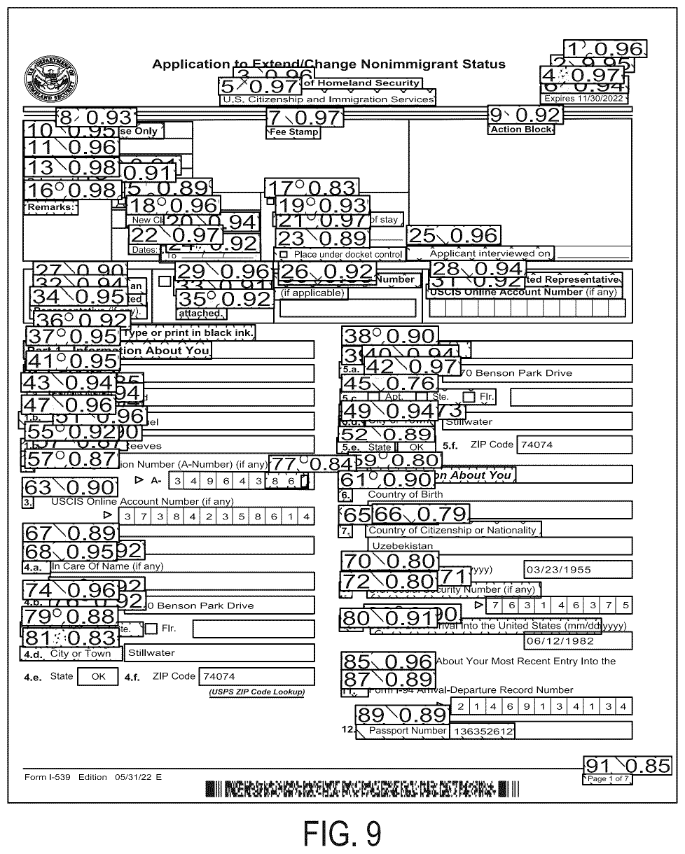

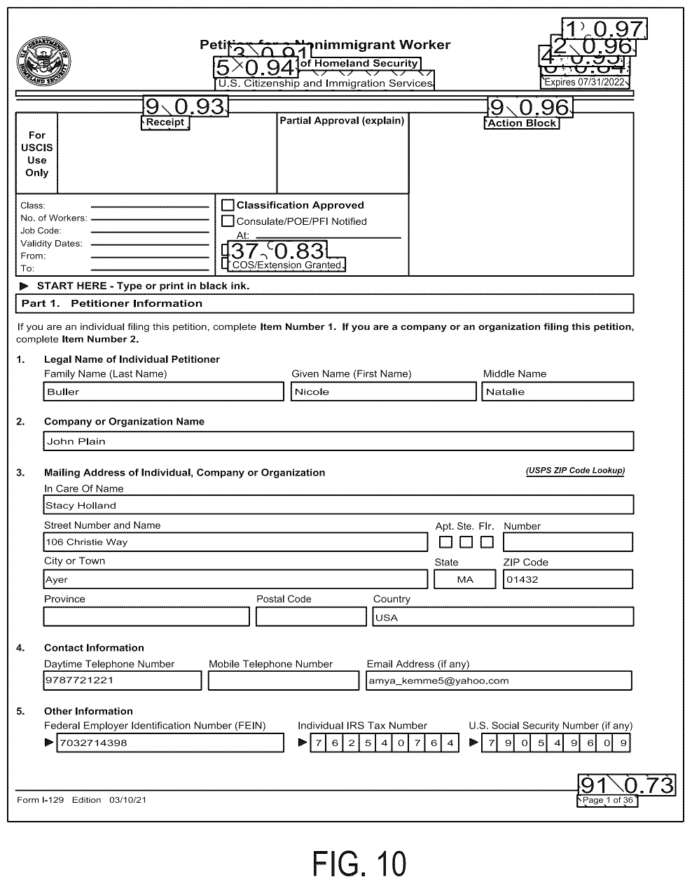

FIG. 9 illustrates an example of feature detection results (e.g., detected ROIs) for a fingerprint that matches the query document image. As illustrated, the query document image can be annotated to indicate the location of each detected feature of the matching fingerprint, along with the index number of the feature within the fingerprint and the confidence level of the feature detection prediction. FIG. 10 illustrates a similar example of feature detection results for a fingerprint that does not match the query document image.

The prediction evaluating module 180 is configured to evaluate the document identification predictions. For example, the prediction evaluating module 180 may be configured to evaluate an output vector that indicates predicted detections of the features of the fingerprints as described above. In some examples, the prediction evaluating module 180 can be configured to process the output vector for a given query document to obtain a corresponding predicted matching (e.g., classification) accuracy for each fingerprint in the gallery on which the multimodal model is trained.

The prediction evaluating module 180 may be configured to generate the predicted matching accuracy for each fingerprint as a score (also called a “match score”) that is based on the number of features of the fingerprint which have been detected (e.g., a feature detection rate, such as [number of detected features of the fingerprint]/[total number of features of the fingerprint]). The prediction evaluating module 180 may be configured to produce a sorted list of the match scores for a given query document image. From the sorted list, the prediction evaluating module 180 may identify the query document image as an instance of the template document that corresponds to the fingerprint having the highest match score.

In examples in which the gallery of fingerprints is incomplete, the prediction evaluating module 180 may compare the highest match score to a threshold. If the match score exceeds (alternatively, is not less than) the threshold, the prediction evaluating module 180 may identify the query document image as an instance of the corresponding template document. Otherwise, the prediction evaluating module 180 may identify the query document image as an unknown document type, and in this case, performance of the multimodal model 145 may be improved by re-training with more template document images and/or more representative samples to cover a wider range of variation.

In some examples, the processes of the model-training computing system 110 and/or the processes of the document-identifying computing system 150 may all be performed as microservices of a remote or cloud computing system, or may be implemented in one or more containerized applications on a distributed system such as by using a container orchestrator such as Kubernetes. Additionally or alternatively, processes of the model-training computing system 110 and/or processes of the document-identifying computing system 150 may be performed locally as modules running on a computing platform associated with the respective computing system. In either case, such a system or platform may include multiple processing devices (e.g., multiple computing devices) that collectively perform the processes. In some examples, the model-training computing system 110 and/or the document-identifying computing system 150 may be accessed through a detection application programming interface (API). The detection API may be deployed as a gateway to a microservice or a Kubernetes system on which the processes of the computing system(s) may be performed. The microservice or Kubernetes system may provide computing power to serve large scale document processing operations.

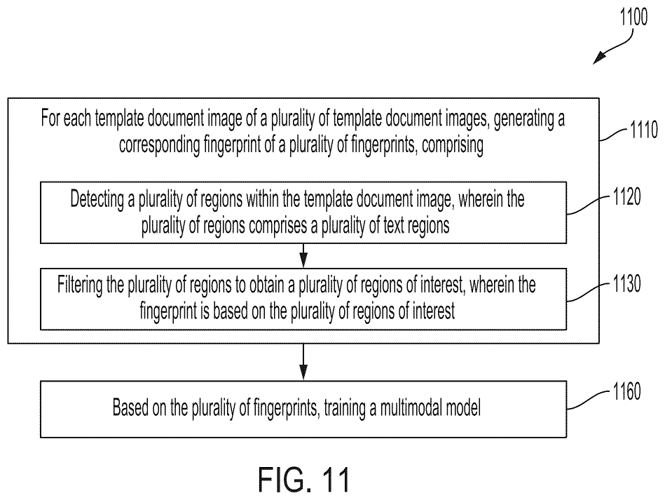

FIG. 11 illustrates an example of a process 1100 of multimodal model training according to certain embodiments of the present disclosure. One or more processing devices, such as one or more computing devices, can implement operations illustrated in FIG. 11 by executing suitable program code. For example, process 1100 may be executed by an instance of the model-training computing system 110. For illustrative purposes, the process 1100 is described with reference to certain examples depicted in the figures. Other implementations, however, are possible.

At block 1110, the multimodal model training process involves generating, such as by a region extracting module as described herein, for each template document image of a set of template document images, a corresponding fingerprint of a set (e.g., gallery) of fingerprints. Each fingerprint of the set of fingerprints may be, for example, a set of features (e.g., in the form of a feature vector) that is characteristic of the corresponding template document image. Each template document image of the set of template document images may be unique among the set of template document images.

Block 1110 includes sub-blocks 1120 and 1130. At block 1120, the multimodal model training process involves detecting, such as by a region detecting module as described herein, a set of regions within the template document image in which the set of regions can include a set of text regions. At block 1130, the multimodal model training process involves filtering, such as by a region filtering module as described herein, the set of regions to obtain a set of regions of interest (ROIs) in which the fingerprint is based on the set of ROIs. The filtering may include selecting at least one text region from among the set of text regions based at least on a number of characters in the text region. Additionally or alternatively, the filtering may include omitting at least one region among the set of regions based on a number of occurrences of the region among the set of template document images. The process 1100 may also include generating augmented data based on the ROIs and the template document images and generating additional multimodal feature vectors based on the augmented data.

At block 1160, the multimodal model training process involves training, such by a training module as described herein, a multimodal model based on the set of fingerprints. The multimodal model may include, for example, a multimodal transformer model. Training the multimodal model may also be based on the additional multimodal feature vectors.

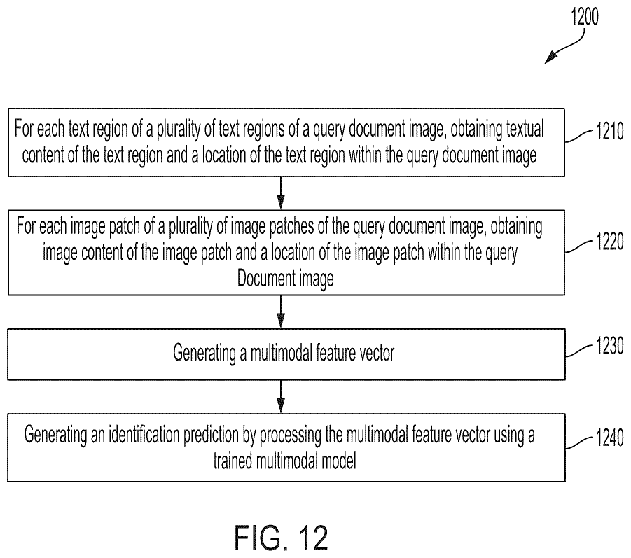

FIG. 12 illustrates an example of a process 1200 of document identification according to certain embodiments of the present disclosure. One or more processing devices, such as one or more computing devices, can implement operations illustrated in FIG. 12 by executing suitable program code. For example, process 1200 may be executed by an instance of the document-identifying computing system 150. For illustrative purposes, the process 1200 is described with reference to certain examples depicted in the figures. Other implementations, however, are possible.

At block 1210, the process 1200 includes obtaining, for each text region of a plurality of text regions of a query document image, textual content of the text region and a location of the text region within the query document image. For example, block 1210 may include performing OCR on the query document image to obtain bounding boxes and corresponding text strings for each text region of the set of text regions.

At block 1220, the process 1200 includes obtaining, for each image patch of a set of image patches of the query document image, image content of the image patch and a location of the image patch within the query document image. For example, the block 1220 may include resizing the query document image, dividing the resized image into patches, generating linear projections of the image patches, and associating each of the projections with its respective location within the image.

At block 1230, the process 1200 includes generating a multimodal feature vector for the query document image. The multimodal feature vector includes, for each text region of a set of text regions of the query document image, an indication of textual content of the text region and an indication of a location of the text region within the query document image. The multimodal feature vector also includes, for each image patch of a plurality of image patches of the query document image, an indication of image content of the image patch and an indication of a location of the image patch within the query document image.

At block 1240, the process 1200 includes generating an identification prediction by processing the multimodal feature vector using a trained multimodal model such as a multimodal model that has been trained according to the process 1100. The multimodal model may be a multimodal transformer model such as an instance of a LayoutLMv3 model.

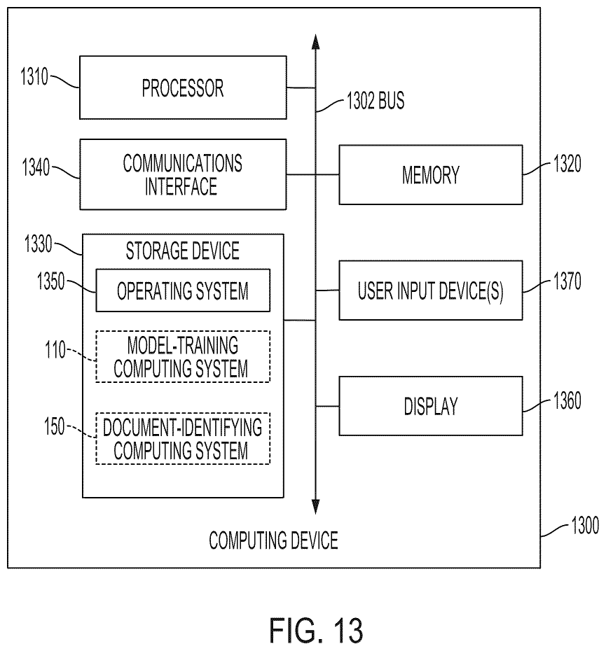

FIG. 13 illustrates an example of a computing device 1300 suitable for implementing aspects of the techniques and technologies presented herein. The computing device 1300 includes a processor 1310 that can be in communication with a memory 1320 and other components of the computing device 1300 using one or more communications buses 1302. The processor 1310 is configured to execute processor-executable instructions stored in the memory 1320 to perform secure data protection and recovery according to different examples, such as part or all of the process 1100 or the process 1200 or other processes described above with respect to FIGS. 1-12. In some examples, the memory 1320 is a non-transitory computer-readable medium that is capable of storing the processor-executable instructions. The computing device 1300, in this example, also includes one or more user input devices 1370, such as a keyboard, mouse, touchscreen, microphone, etc., to accept user input. The computing device 1300 also includes a display 1360 to provide visual output to a user. In other examples of a computing device (e.g., a device within a cloud computing system), such user interface devices may be absent.

The computing device 1300 can also include or be connected to one or more storage devices 1330 that provide non-volatile storage for the computing device 1300. The storage devices 1330 can store an operating system 1350 utilized to control the operation of the computing device 1300. The storage devices 1330 can also store other system or application programs and data utilized by the computing device 1300, such as modules implementing the functionalities provided by the model-training computing system 110, the document-identifying computing system 150, or any other functionalities described above with respect to FIGS. 1-12. The storage devices 1330 may store other programs and data not specifically identified herein.

The computing device 1300 can include a communications interface 1340. In some examples, the communications interface 1340 may enable communications using one or more networks including: a local area network (“LAN”); wide area network (“WAN”), such as the Internet; metropolitan area network (“MAN”); point-to-point or peer-to-peer connection; etc. Communication with other devices may be accomplished using any suitable networking protocol. Examples of suitable networking protocols may include Internet Protocol (“IP”), Transmission Control Protocol (“TCP”), User Datagram Protocol (“UDP”), or combinations thereof, such as TCP/IP or UDP/IP.

While some examples of methods and systems herein are described in terms of software executing on various machines, the methods and systems may also be implemented as specifically configured hardware, such as field-programmable gate arrays (FPGAs) specifically, to execute the various methods. For example, examples can be implemented in digital electronic circuitry, or in computer hardware, firmware, software, or in a combination thereof. In one example, a device may include one or more processing devices, such as a processor or processors. The processor can include a computer-readable medium, such as a random access memory (RAM), coupled to the processor. The processor can execute computer-executable program instructions stored in memory. Such processors may include a microprocessor, a digital signal processor (DSP), an application-specific integrated circuit (ASIC), field programmable gate arrays (FPGAs), and state machines. Such processors may further be or include programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may be or include, or may be in communication with, media (e.g., computer-readable storage media) that may store instructions that, when executed by the processor, can cause the processor to perform the steps described herein as carried out, or assisted, by a processor. Examples of computer-readable media may include an electronic, optical, magnetic, or other storage device capable of providing a processor, such as the processor in a web server, with computer-readable instructions. Other examples of media can include a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may include code for carrying out one or more of the methods, or portions thereof, described herein.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C. For the purposes of the present document, the phrase “A is based on B” means “A is based on at least B”.

Different arrangements of the components depicted in the drawings or described above, as well as components and steps not shown or described are possible. Similarly, some features and sub-combinations are useful and may be employed without reference to other features and sub-combinations. Embodiments of the presently subject matter have been described for illustrative and not restrictive purposes, and alternative embodiments will become apparent to readers of this patent. Accordingly, the present disclosure is not limited to the embodiments described above or depicted in the drawings, and various embodiments and modifications may be made without departing from the scope of the claims below.

1. A computer-implemented method of document image processing, the method comprising:
for each template document image of a plurality of template document images, generating a corresponding fingerprint of a plurality of fingerprints; and
based on the plurality of fingerprints, training a multimodal model, wherein, for each template document image of the plurality of template document images, generating the corresponding fingerprint comprises:
detecting a plurality of regions within the template document image, wherein the plurality of regions comprises a plurality of text regions; and
filtering the plurality of regions to obtain a plurality of regions of interest, wherein the fingerprint is based on the plurality of regions of interest.

2. The computer-implemented method of claim 1, wherein each template document image of the plurality of template document images is unique among the plurality of template document images.

3. The computer-implemented method of claim 1, wherein the plurality of template document images comprises:
a first template document image that is an image of a first edition of a form document, and
a second template document image that is an image of a second edition of the form document that is different than the first edition.

4. The computer-implemented method of claim 1, wherein, for each template document image of the plurality of template document images, filtering the plurality of regions comprises:
applying a first filter to select, from among the plurality of regions, a first plurality of selected regions; and
applying a second filter to omit, from among the first plurality of selected regions, at least one selected region to obtain a second plurality of selected regions.

5. The computer-implemented method of claim 4, wherein, for each template document image of the plurality of template document images, applying the first filter comprises selecting at least one text region from among the plurality of text regions based at least on a number of characters in the text region.

6. The computer-implemented method of claim 4, wherein, for each template document image of the plurality of template document images, applying the first filter comprises selecting at least one text region from among the plurality of text regions based at least on a number of characters in the text region and natural language processing (NLP) non-stop words.

7. The computer-implemented method of claim 4, wherein, for each template document image of the plurality of template document images, applying the second filter comprises omitting at least one region of the at least one selected region based on a number of occurrences of the region among the plurality of template document images.

8. The computer-implemented method of claim 7, wherein the plurality of regions of interest includes the second plurality of selected regions.

9. The computer-implemented method of claim 1, wherein each fingerprint of the plurality of fingerprints includes a feature vector that is based on a corresponding plurality of regions of interest.

10. The computer-implemented method of claim 1, wherein, for each template document image of the plurality of template document images, each text region of the plurality of text regions indicates:
a text string detected within the text region, and
a boundary of the text region within a corresponding template document image.

11. The computer-implemented method of claim 1, wherein, for each template document image of the plurality of template document images, each text region of the plurality of text regions indicates:
a text string detected within the text region, and
a location and image patch of the text region within a corresponding template document image.

12. The computer-implemented method of claim 1, wherein, for each template document image of the plurality of template document images, the plurality of regions includes at least one image region, and each image region of the at least one image region indicates:
a boundary of the image region within a corresponding template document image, and
image content of the image region.

13. The computer-implemented method of claim 1, further comprising, for each template document image of the plurality of template document images:
generating augmented data that is based on information from the template document image, and
generating a plurality of training samples that are based on the augmented data, wherein training the multimodal model comprises using the plurality of training samples for each template document image of the plurality of template document images to train the multimodal model.

14. The computer-implemented method of claim 1, wherein the multimodal model includes a multimodal transformer model.

15. A system comprising:
one or more processing devices; and
one or more non-transitory computer-readable media communicatively coupled to the one or more processing devices, wherein the one or more processing devices are configured to execute program code stored in the non-transitory computer-readable media and thereby perform operations comprising:
for each template document image of a plurality of template document images, generating a corresponding fingerprint of a plurality of fingerprints; and
based on the plurality of fingerprints, training a multimodal model, wherein, for each template document image of the plurality of template document images, generating the corresponding fingerprint comprises:
detecting a plurality of regions within the template document image, wherein the plurality of regions comprises a plurality of text regions; and
filtering the plurality of regions to obtain a plurality of regions of interest, wherein the fingerprint is based on the plurality of regions of interest.

16. The system of claim 15, wherein each template document image of the plurality of template document images is unique among the plurality of template document images, and wherein the plurality of template document images comprises:
a first template document image that is an image of a first edition of a form document, and
a second template document image that is an image of a second edition of the form document that is different than the first edition.

17. The system of claim 15, wherein, for each template document image of the plurality of template document images, filtering the plurality of regions comprises:
applying a first filter to select, from among the plurality of regions, a first plurality of selected regions; and
applying a second filter to omit, from among the first plurality of selected regions, at least one selected region to obtain a second plurality of selected regions.

18. One or more non-transitory computer-readable media storing computer-executable instructions to cause one or more processing devices to perform operations comprising:
for each template document image of a plurality of template document images, generating a corresponding fingerprint of a plurality of fingerprints; and
based on the plurality of fingerprints, training a multimodal model, wherein, for each template document image of the plurality of template document images, generating the corresponding fingerprint comprises:
detecting a plurality of regions within the template document image, wherein the plurality of regions comprises a plurality of text regions; and
filtering the plurality of regions to obtain a plurality of regions of interest, wherein the fingerprint is based on the plurality of regions of interest.

19. The one or more non-transitory computer-readable media of claim 18, wherein each fingerprint of the plurality of fingerprints includes a feature vector that is based on a corresponding plurality of regions of interest, and wherein, for each template document image of the plurality of template document images, each text region of the plurality of text regions indicates:
a text string detected within the text region, and
a boundary of the text region within a corresponding template document image.

20. The one or more non-transitory computer-readable media of claim 18, wherein, for each template document image of the plurality of template document images, each text region of the plurality of text regions indicates:
a text string detected within the text region, and
a location and image patch of the text region within a corresponding template document image.
